(19) United States
(12) Patent Application Publication
(10) Pub. No.: US 2005/0021314 A1
(43) Pub. Date: Jan. 27, 2005

(54) Method for providing design review and conformity

(76) Inventors: Jeffrey A Rose, Harrison Township, MI (US); James D. Dalpizzol, Clinton Township, MI (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 10/486,944

(22) PCT Filed: Aug. 14, 2002
(86) PCT No.: PCT/US02/25784

Related U.S. Application Data
(60) Provisional application No. 60/312,111, filed on Aug. 14, 2001.

(51) Int. Cl. G06F 19/00

(52) U.S. Cl. 703/1; 700/98; 700/97; 700/104

(57) ABSTRACT

A method and apparatus for updating a design knowledge base, comprising supplying a design knowledge base (14) in a selected domain, the design knowledge base configured to obtain user input (24) of a selected design and to output a design directive. A response is received from the design knowledge base to the user input of a selected design wherein the response comprises a set of design review inquiries to direct the user to incorporate the design directive. A knowledge base maintainer is supplied (35) in communication with design knowledge base wherein the knowledge base maintainer generates an output response in response to a user's response to the design review inquiries, wherein the output response directs the user to modify the user selected design to conform with the design directive or the user requests the knowledge base maintainer to confirm that the user's the design directive provided by the design knowledge base wherein the knowledge base maintainer adjusts the design knowledge base to incorporate the improvement.

### FIELD OF THE INVENTION

This invention relates to information systems that produce a design review in a particular design domain in order to help an information user, such as a designer or engineer, designing in the domain.

### BACKGROUND OF THE INVENTION

Computer systems have been utilized in an effort to develop expert systems which include the capability of learning knowledge during operation. For example, U.S. Pat. No. 5,208,768 describes an expert system including an arrangement for acquiring redesign knowledge.

More specifically, the expert system in the aforementioned patent is said to perform a redesign in connection with an original design. The expert system comprises a discrepancy determination component that identifies a discrepancy between operation of the original design and the desired operation. A redesign component including at least one redesign module associated with a discrepancy generates a redesign in response to the original design and the identified discrepancy. Finally, a redesign generation component generates a redesign module in response to a previously identified discrepancy and design, the redesign module thereafter being used by the redesign component.

Accordingly, a need remains to provide an improved knowledge-based engineering system which provides design, manufacturing and/or business advice. Therefore, it is a general object of this invention to provide such improved knowledge-based engineering system, and more specifically, a system which contains a closed feedback loop to the system user.

More specifically, it is also an object of the invention herein to provide such a system, wherein the system provides relevant advice based upon expert knowledge from engineers, integrated databases of related engineering information along with a prioritization of attributes for the specific field.

### SUMMARY OF THE INVENTION

A system and method of updating a design knowledge base, the method comprising the steps of receiving a response to a generated inquiry, and requesting the design knowledge base be reevaluated if a new design is conceived that is equal or better to an existing design if the response to the inquiry is negative. More specifically the present invention is directed at a method and apparatus for updating a design knowledge base, comprising supplying a design knowledge base containing information regarding designing in a selected domain, the design knowledge base configured to obtain user input of a selected design and to output a design directive. A response is received from the design knowledge base to the user input of a selected design wherein the response comprises a set of design review inquiries to direct the user to incorporate the design directive. A knowledge base maintainer is supplied in communication with the design knowledge base wherein the knowledge base maintainer generates an output response in response to a user's response to the design review inquiries, wherein the output response directs the user to modify the user selected design to conform with the design directive or the user requests the knowledge base maintainer to confirm that the user's design comprises an improvement over the design directive provided by the design knowledge base wherein the knowledge base maintainer adjusts the design knowledge base to incorporate the improvement.

### BRIEF DESCRIPTION OF THE DRAWINGS

These and other objects, features and advantages of the invention will become apparent upon consideration of the description of the invention and the appended drawings in which:

FIG. 1 illustrates the overall structure of the invention which includes the principal components of each of the mechanisms and how the mechanisms are employed in the design process; and

FIG. 2 illustrates the structure of the knowledge base in a preferred embodiment.

The above and other objects, feature, and advantages of the present invention will be apparent in the following detailed description thereof when read in conjunction with the appended drawings wherein the same reference characters denote the same or similar parts throughout the several views.

### DESCRIPTION OF THE PREFERRED EMBODIMENTS

As noted above, the present invention is directed at a method and system for updating a design knowledge base, comprising supplying a design knowledge base containing information regarding designing in a selected domain, the design knowledge base configured to obtain user input of a selected design and to output a design directive. A response is received from the design knowledge base to the user input of a selected design wherein the response comprises a set of design review inquiries to direct the user to incorporate the design directive. A knowledge base maintainer is supplied in communication with the design knowledge base wherein the knowledge base maintainer generates an output response in response to a user's response to the design review inquiries, wherein the output response directs the user to modify the user selected design to conform with the design directive or the user requests the knowledge base maintainer to confirm that the user's design comprises an improvement over the design directive provided by the design knowledge base wherein the knowledge base maintainer adjusts the design knowledge base to incorporate the improvement.

In system form, the present invention is directed at a design system, comprising a design knowledge database storing a plurality of design parameters, a maintenance engine adapted to change said design parameters in the design knowledge database and a design engine adapted to interact with a design process user to give the user access to relevant information from the design knowledge database wherein said design engine further adapted to permit said user to create a new design parameter not in said design knowledge database, store said new design parameter in said design knowledge database, and further adapted to incorporate said new design parameter in future designs.

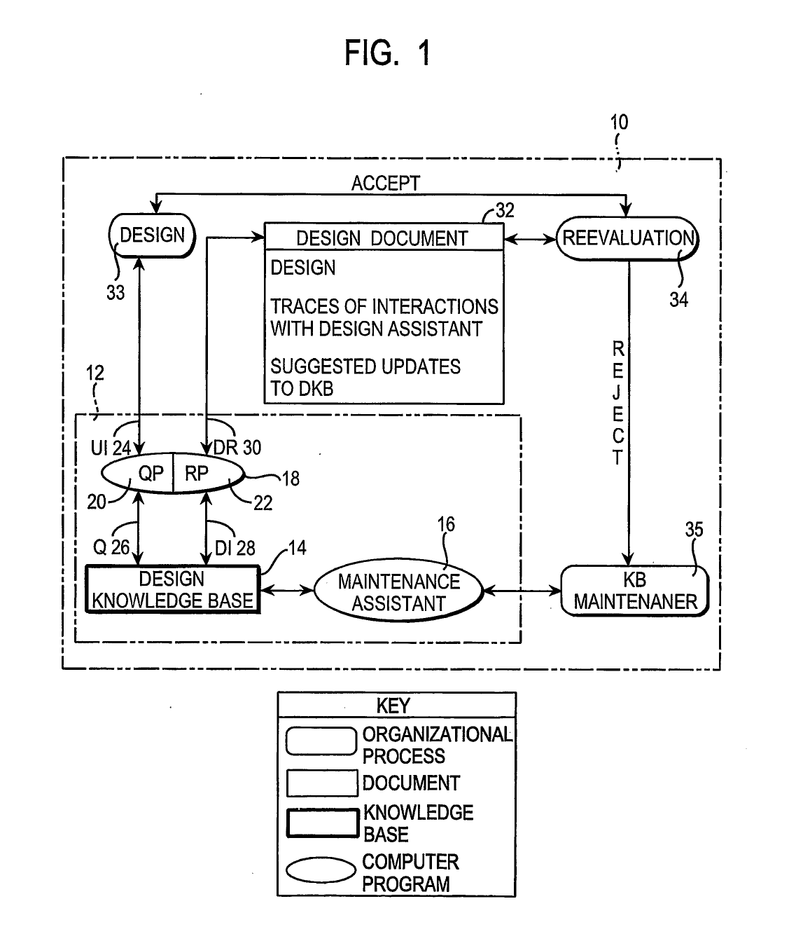

In accordance with the invention, an exemplary design process 10 is shown in FIG. 1. Design process 10 includes an artificial intelligence system 12 located therein. The artificial intelligence system 12 comprises a design knowledge base 14, a maintenance assistant 16, and a design assistant 18.

The design knowledge base 14 comprises information about designing in a particular domain and may be used in a design review. The design knowledge base 14 comprises design information which may be queried, for example, by product and/or process domains. For example, the domain may comprise product design information related to automotive components for a motor vehicle. The automotive components may comprise, but are not limited to, instrument panels, door panels, bumpers, etc. The domain may also comprise process design information related to polymer processing methods. The methods may comprise, but are not limited to, injection molding, slush molding, painting, foam-in-place molding; etc.

The terms “computer program” and “software”, as used herein, are to be interpreted broadly as any computer-readable memory device holding one or more executable processes. These processes are intended to be executed by a processor in a manner consistent with the present invention. Also, the present invention shall refer to various processes as interacting with humans or other processes. Those skilled in the art will recognize that human interaction with any of the foregoing processes may be accomplished, for example, using a graphical user interface system to display relevant data and to permit human users to exchange commands and data with the associated process.

Those skilled in the art will recognize that the knowledge base 14 represents a database of design information. Each of the functional components associated with the artificial intelligence system 12 is embodied by running distributed computer program processes (e.g., generated using “full-scale” relational database engines such as IBM DB2™, SQLServer™, Oracle 7.3™ or Oracle 8.0™ database managers) on networked computer systems (e.g., comprising mainframe and/or symmetrically or massively parallel computing systems such as the IBM SB2™ or HP™ 9000 computer systems) including appropriate mass storage, networking, and other hardware and software for permitting these functional components to achieve the stated function. These computer systems may be geographically distributed and connected together via appropriate wide- and local-area network hardware and software.

Alternatively, the aforesaid functional components may be embodied by a plurality of separate computer processes (e.g., generated via dBase™, Xbase™, MSAccess™ or other “flat file” type database management systems or products) running on IBM-type, Intel Pentium™ or RISC microprocessor-based personal computers networked together via conventional networking hardware and software and including such other additional conventional hardware and software as is necessary to permit these functional components to achieve the stated functionalities. In this alternative configuration, since such personal computers typically are unable to run full-scale relational database engines of the types presented above, a non-relational flat file “table” (not shown) may be included in at least one of the networked personal computers to represent at least portions of the knowledge base data and/or input information thereto. Preferably, these personal computers run the Unix, Microsoft Windows N™ or Windows 98™ or Windows 2000™ operating systems. The aforesaid functional components of system 12 may also be comprised by a combination of the above two configurations (e.g., by computer program processes running on a combination of personal computers, RISC systems, mainframes, symmetric or parallel computer systems, and/or other appropriate hardware and software, networked together via appropriate wide and local area network hardware and software).

The maintenance assistant 16 is a computer program that interacts with a knowledge base maintainer 35 to change information, such as adding new information, and/or revising or deleting existing information, in the design knowledge base 14. Design information included in the design knowledge base 14 may be provided from multiple sources. For example, design information for the design knowledge base 14 may be provided from technical experts in a particular domain. Alternatively, design information for the design knowledge base 14 may be provided from product and/or process quality initiatives, including product and process validation reports. The source of the quality initiatives may comprise historical data generated from previously utilized products and processes. Exemplary quality initiatives include design failure mode and effects analysis (DFMEA), process failure mode and effects analysis (PFMEA), production part approval process (PPAP), 8D, statistical process control (SPC) and design of experiments (DOE). Also alternatively, design information for the design knowledge base 14 may be provided from warranty data, such as service reports.

The design assistant 18 is a computer program that interacts with a design process user, such as a designer or engineer, to give the user access to relevant information from the design knowledge base 14. Furthermore, the combination of the design information in the design knowledge base 14 and the design assistant 18 must allow design process users easy access to relevant design information. As shown in FIG. 1, the design assistant 18 comprises a query provider (QP) 20 and a review provider (RP) 22.

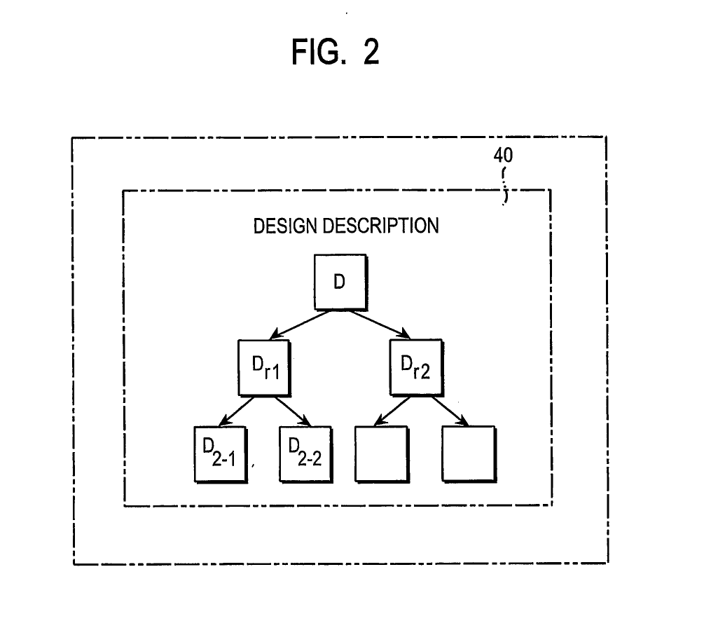

The query provider 20 may be menu selection driven or keyword driven. In first considering a menu driven query provider within the realm of product design, for example, the design assistant 18 may be configured to obtain user input of his specific design from a menu driven query comprising a tiered, descending hierarchy (i.e. “decision tree”) of design descriptions 40 as shown in FIG. 2, in which each sub-domain is a subset of the previous domain.

For example, in the domain (D) of automotive components, the design assistant may be configured to initially present a first-tier menu of sub-domains in the next lower tier comprising instrument panel assemblies D₁₋₁ and bumper assemblies D₁₋₂, etc. to D_{1-N}, where the first numerical character represents the level and the second numerical character represents the specific number of the selection and n represents the total number of selections.

In continuing with the tier down, upon user input of a first-tier selection D_{1-N} from the first-level tier down removed from the domain, the design assistant 18 may then be configured to next present a second-tier menu comprising sub-domains from the next lower level. For example, upon selection of a first-level user input D₁₋₂, such as a bumper assembly, the design assistant 18 would be configured to present a second-tier menu of sub-domains comprising the individual components of the bumper assembly, such as the fascia D₂₋₁ and energy absorber D₂₋₂.

Upon user input of a second-tier selection D_{2-N} from the second-level tier down removed from the domain, the sub-domains may be further sub-divided into further design descriptions in the above manner (i.e. via presentation of, and user selection from, an input selection menu) to reach the lowest level hierarchy of the domain.

Alternatively, to the above menu driven query, the design assistant 18 may be configured to obtain user input from a keyword query.

It should be understood that the goal of the above interaction is to allow the design process user to classify his design under the most specific relevant design description as to result in the most specific possible design review. Furthermore, while the above operation of the design assistant 18 has been described relative to product design, it should be understood that it equally applies to process design.

With regards to operation of the artificial intelligence system 12 within the design process 10, the design process user (i.e. designer, engineer) first interacts with the query provider 20 portion of the design assistant 18 by providing user input (UI) 24. As indicated above, the user input 24 may be input from a selection menu or keyword.

Upon being provided with the user input 24, the design assistant 18 queries the design knowledge base 14 with query (Q) 26 to access design information relevant to the design process user. The design knowledge base 14 then provides design information (DI) 28 to the design assistant 18. In turn, the review provider 22 portion of the design assistant 18 presents the relevant information as design review (DR) 30 to the design process user as review inquires.

In response to the user design description input, a design document 32 comprising a predetermined set of design review inquires (e.g. questions), with a priority ranking, such as high, medium or low for each inquiry, is generated from the reviewer provider 22 portion of the design assistant 18. The inquires are configured to elicit a binary (e.g. affirmative “yes” or negative “no”) response from the user concerning their design, and may be generated at any tier level of the design knowledge base 14. Preferably, the inquires are structured in which an affirmative answer is the “correct” choice (i.e. the design is in conformance with the design information contained in the design knowledge base 14).

Depending on the priority of the inquiry, a response from the user which is found not to be in conformance with the design information in the design knowledge base 14, preferably automatically generate an output response (e.g. e-mail) from the knowledge base maintainer 35 informing the user that the design is not in conformance with the design information in the design knowledge base 14, and directing the user to modify his design into conformity with the design information in the design knowledge base 14. Such a response from the knowledge base maintainer 35 is typically reserved for high priority inquiries.

If the design process user is of the belief that any aspect of his design is improved from the current design directive provided by the design knowledge base 14, the design process user may request (e.g. e-mail) a reevaluation 34 to be conducted by the knowledge base maintainer 35 to confirm/disconfirm such. If the knowledge base maintainer 35 confirms that the design process user's design comprises an improvement over the existing design directive provided by the design knowledge base 14, the knowledge base maintainer 35 will revise the design knowledge base 14 to incorporate the improvement provided by the design process user.

Maintaining the design knowledge base 14 involves the knowledge base maintainer 35 interacting with the maintenance assistant 16 to update the design knowledge base 14 based on the modifications and additions discovered to be necessary during design 33 and reevaluation 34.

Upon revision of the design knowledge base 14 to incorporate such, preferably an output response (e.g. e-mail) is automatically generated from the knowledge base maintainer 35 informing the user that his design improvement has been incorporated into such, and that his design is in conformance with the design information in the design knowledge base 14.

As can therefore be seen from the above, the system herein provides relevant advice regarding an design input and a comparison between the advice and the design are automatically performed through an HTML search engine. Results of the comparison become part of a user and design gate review document integral to the system. The advice becomes part of a living design document. The system includes a method of updating the knowledge base, and requires feedback to the expert system if deviant from the expert advice. A preferred embodiment of the system is used to provide advice through a graphical interface to designers located on an engineering software system.

The description and drawings illustratively set forth the presently preferred invention embodiments. The description and drawings are intended to describe such embodiments and not to limit the scope of the invention. Those skilled in the art will appreciate that still other modifications and variations of the present invention are possible in light of the above teaching while remaining within the scope of the following claims. Therefore, one may practice the invention otherwise than as the description and drawings specifically show and describe.

1. A method of updating a design knowledge base, comprising:
(a) supplying a design knowledge base (14) containing information regarding designing in a selected domain, said design knowledge base configured to obtain user input (24) of a selected design and to output a design directive;
(b) receiving a response from said design knowledge base to said user input of a selected design wherein said response comprises a set of design review inquiries to direct said user to incorporate said design directive;
(c) supplying a knowledge base maintainer (35) in communication with said design knowledge base wherein said knowledge base maintainer generates an output response in response to a user's response to said design review inquiries, wherein said output response:
(i) directs said user to modify said user selected design to conform with said design directive; or
(ii) said user requests said knowledge base maintainer to confirm that said user's design comprises an improvement over said design directive provided by the design knowledge base wherein said knowledge base maintainer adjusts said design knowledge base to incorporate said improvement.

2. The method of claim 1 wherein said design knowledge base containing information regarding designing in a particular domain is configured for designing automotive components.

3. The method of claim 2 wherein said design knowledge base comprises historical data generated from previously utilized products and processes.

4. A method of communicating with a design knowledge base to inform a user about designing in a particular domain, comprising:
(a) supplying a design knowledge base (14) containing information regarding designing in a selected domain, said design knowledge base configured to obtain user input (24) of a selected design and to output a design directive;
(b) receiving a response from said design knowledge base to said user input of a selected design wherein said response comprises a set of design review inquiries to direct said user to incorporate said design directive;
(c) supplying a knowledge base maintainer (35) in communication with said design knowledge base wherein said knowledge base maintainer generates an output response in response to a user's response to said design review inquiries, wherein said output response directs said user that said user selected design does not conform with said design directive.

5. The method of claim 4 wherein said design knowledge base containing information regarding designing in a particular domain is configured for designing automotive components.

6. The method of claim 5 wherein said design knowledge base comprises historical data generated from previously utilized products and processes.

7. A design system, comprising:
a design knowledge database storing a plurality of design parameters, a maintenance engine adapted to change said design parameters in the design knowledge database; and
a design engine adapted to interact with a design process user to give the user access to relevant information from the design knowledge database;
wherein said design engine further adapted to permit said user to create a new design parameter not in said design knowledge database, store said new design parameter in said design knowledge database, and further adapted to incorporate said new design parameter in future designs.
